(19) United States
(12) Patent Application Publication
(10) Pub. No.: US 2014/0061111 A1
(43) Pub. Date: Mar. 6, 2014

(54) ENCAPSULATED WATER FILTER MEDIA ASSEMBLY

(71) Applicant: AUGUSTIN PAVEL, TEMECULA, CA (US)

(72) Inventor: AUGUSTIN PAVEL, TEMECULA, CA (US)

(21) Appl. No.: 14/019,237

(22) Filed: Sep. 5, 2013

Related U.S. Application Data
(60) Provisional application No. 61/696,919, filed on Sep. 5, 2012.

(51) Int. Cl. B01D 35/30; B01D 24/16; B01D 69/04; B01D 29/00

(52) U.S. Cl. CPC B01D 35/30; B01D 29/0002; B01D 24/16; B01D 69/04
USPC 210/232; 210/437; 210/287; 210/321.6; 210/323.2

(57) ABSTRACT

A disposable encapsulated water purification media assembly including a hollow cylindrical core member, a top end cap permanently attached to a top portion of the cylindrical core member, and a bottom end cap permanently attached to a bottom portion of the cylindrical core member, such that the cylindrical core member, top end cap, and bottom end cap form a void capable of directly containing a water purification media.

### CROSS-REFERENCE TO RELATED APPLICATIONS

This application claims the benefit of U.S. Provisional Application No. 61/696,919, filed on Sep. 5, 2012, the teachings of which are expressly incorporated by reference.

### STATEMENT RE: FEDERALLY SPONSORED RESEARCH/DEVELOPMENT

Not Applicable

### BACKGROUND

1. Field of the Invention

The present disclosure relates generally to water purification systems, and especially to an encapsulated media assembly for use in water purification systems. More particularly, the present disclosure concerns a fully integrated and sealed capsule containing various water purification media, thereby eliminating the need for a separate housing.

2. Description of the Prior Art

Reverse osmosis membranes, as well as numerous other water treatment media, are commonly contained within a housing made of stainless steel, fiberglass, or a thermoplastic. These housings, however, must have removal end sections or caps to allow for access to the media for replacement purposes. In water purification processes, particularly reverse osmosis, the fluid contained within the housing is pressurized, thereby exerting a great force on the removable end caps. In order to maintain the end caps in position on the housing under such pressurization, various methods of securing the end caps have been utilized in the prior art, including the use of multiple securing pins as well as the hand-assembled plastic reverse osmosis membrane housing described in U.S. Pat. No. 5,595,651, the entirety of which is incorporated herein by reference.

By using a permanent housing, capable of receiving water treatment media, the prior art systems require the additional expense of a housing capable of withstanding high pressure in a unit that, out of necessity, must also be separable to exchange the media when it has reached the end of its usefulness. Additionally, in the case of reverse osmosis membranes, the use of a separate housing that does not perfectly abut the membrane requires the use of many additional expense features such as brine seals, anti-telescoping devices, and/or carriers, all of which may be omitted if one were to forego the use of a separate housing. These “features” may also allow the housing to maintain stale water that develops behind the brine seal leading to potentially unsanitary conditions.

While there have been some attempts at eliminating the use of a housing, they have all been via small cartridges with low flow rates that plug into a separate manifold. As such, there is a need for an encapsulated media assembly with high flow rates that does not require the use of a housing or a manifold.

### BRIEF SUMMARY

In accordance with one embodiment of the present disclosure, there is contemplated a disposable encapsulated water purification media assembly. The media assembly includes a hollow cylindrical core member, a top end cap permanently attached to a top portion of the cylindrical core member, and a bottom end cap permanently attached to a bottom portion of the cylindrical core member. Both the top and bottom end caps include a side port. However, the bottom end cap side port may be disposed on the opposite side in relation to the top end cap side port. The cylindrical core member, top end cap, and bottom end cap form a hollow void that contains a water purification media. This configuration allows the assembly to be attached to a water supply without the use of a separate housing or manifold.

In regard to the construction, the hollow cylindrical core member, top end cap, and bottom end cap may be formed from acrylonitrile butadiene styrene (ABS). Further, both side ports may be 1/2 inch, 3/4 inch, or one side port may be 1/2 inch and one side port may be 3/4 inch. The side ports may be female national pipe thread (FNPT), push-to-connect, combinations thereof, or any other suitable standard type of connector.

The water purification media may be a filtration media. More particularly, the filtration media may be carbon. When utilizing a filtration media, the bottom side port may be a water entry port and the top side port may be a water exit port.

The water purification media may be a reverse osmosis membrane. When utilizing a reverse osmosis membrane, the bottom side port may be a water entry port, the top side port may be a waste exit port, and the top end cap may further include a centrally located purified water exit port. In one embodiment, the reverse osmosis membrane operates at a pressure of approximately 80 psi. Alternatively, the water purification media may be a selective ion resin.

Another embodiment of the present disclosure envisions a water purification system that includes at least one encapsulated water purification media assembly. The media assembly is connectable to an incoming water supply, and includes a hollow cylindrical core member, a top end cap permanently attached to a top portion of the cylindrical core member, and a bottom end cap permanently attached to a bottom portion of the cylindrical core member. The cylindrical core member, top end cap, and bottom end cap serve to form a void that directly encapsulates a water purification media. Further, the top end cap includes a side port and the bottom end cap includes a side port disposed on the opposite side in relation to the top end cap side port.

The water purification system may include more than one encapsulated water purification media assembly. In the case where the system includes more than one encapsulated water purification media assembly, the assemblies may contain different or the same purification media. Further, these multiple assemblies may be attached in a serial fashion, and may be done so without requiring the use of a separate manifold, i.e., the multiple assemblies may be directly plumbed together.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an encapsulated water purification media assembly in accordance with various embodiments of the present disclosure;

FIG. 2 is a top view of the encapsulated water purification media assembly;

FIG. 3 is a side view of the encapsulated water purification media assembly; and

FIG. 4 is a cross-sectional view of the encapsulated water purification media assembly.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

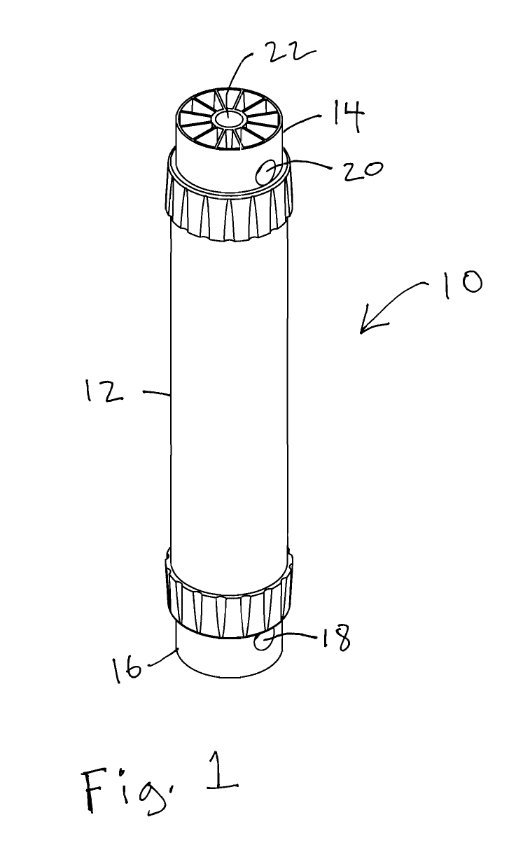

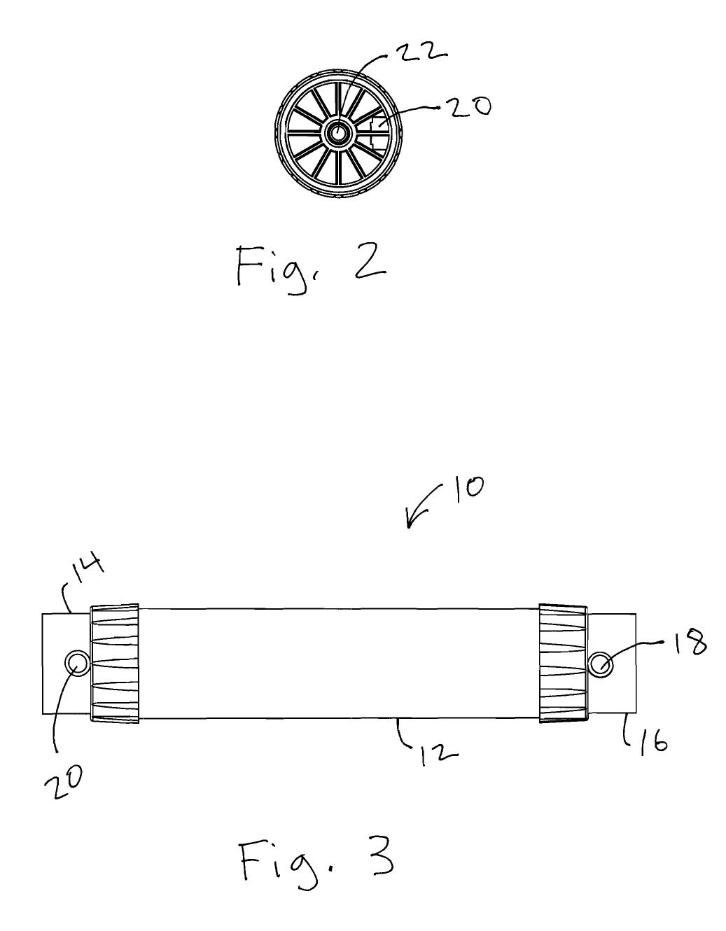

Referring to FIG. 1, one embodiment of a disposable encapsulated water purification media assembly 10 is generally comprised of a hollow cylindrical core member 12, a top end cap 14 permanently attached to a top portion of the cylindrical core member 12, and a bottom end cap 16 permanently attached to a bottom portion of the cylindrical core member 12. As can readily be understood the hollow cylindrical core member 12, sealed on both ends by the top end cap 14 and the bottom end cap 16, creates a void that is capable of directly containing various water purification media. As can be seen, the bottom end cap 16 may include a side port 18 that allows for the ingress and/or egress of a fluid, such as water, while the top end cap 14 may likewise include a side port 20. In some embodiments, the bottom side port 18 and the top side port 20 may be disposed on opposite sides of the core member 12, thereby allowing direct flow through of the liquid from one side of the assembly 10 to the other.

By configuring the encapsulated assembly 10 in such a manner, it eliminates the need for a housing of some sort that would typically contain a water purification media cartridge. Instead, the media within the encapsulated assembly 10 performs as normal while the outside core member 12 and end caps 14, 16 act as the housing. However, there is no separation between the media and the housing as would be found in the prior art, as such the purification media is contained directly within the assembly 10, thereby being encapsulated.

It is contemplated that the end caps 14, 16 and the core member 12 may be formed of a thermoplastic to make the assembly 10 a cost effective alternative to the prior art, which typically requires metal housings. In particular, the end caps 14, 16 and core member 12 may be injection molded out of acrylonitrile butadiene styrene (ABS). However, metal and other types of materials may be used within the construction of the assembly, indeed the end caps and core member may even be formed of dissimilar materials. Further, the side ports 18, 20 may be formed in various port sizes such as in a threaded female national pipe thread (FNPT) style and/or a quick connect style (integrated push/pull fittings) in standard sizes, such as 1/2 inch and 3/4 inch sizes. The sizes and form of the ports 18, 20 may be adjusted as is commonly known within the art and may be the same size and type on both ends of the assembly 10, or may differ on opposite ends of the assembly 10 as needs arise.

Depending on the media used inside of the encapsulation, various port configurations can be used. For instance, if carbon is being used for the reduction of chlorine, the user may plumb the configuration from the bottom end port 18 on one side to the top end port 20 on the other side. This will allow for straight flow through. As can be seen, however, the orientation of the end ports may be varied before the bonding of the end caps to the core member as needed for various installations.

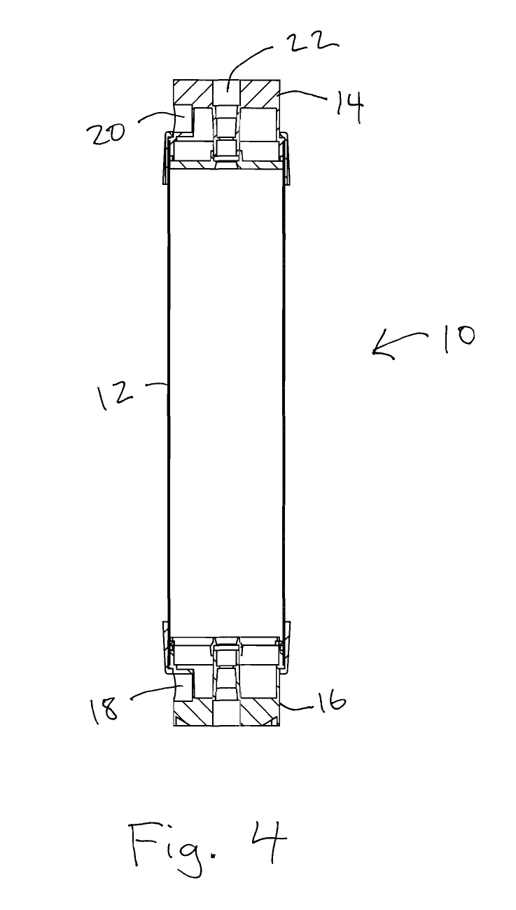

As shown in FIGS. 1 and 4, if a reverse osmosis membrane is used inside the assembly 10, then the user may plumb it on the bottom from the side port 18 and have the product flow out of a top end port 22 on the other side of the assembly 10 and the waste to flow from the top side port 20.

When the end caps 14, 16 are bonded to the core member 12, preferably via gluing (however, any standard method may be utilized), they make up a completed assembly 10 which encapsulates the media inside. An encapsulated media means that once it is used up or expired, the entire assembly 10 is removed and discarded, rather than just replacing the media inside which is done as a standard in the prior art. However, when the end caps 14, 16 and the core member 12 are formed from ABS, it is possible for the user to cut open the assembly 10, discard the media, and recycle the end caps 14, 16 and core member 12 readily easily.

As can be seen, due to the unique nature of the assembly 10, various media may be used inside of the assembly 10. Exemplary media that may be used within the assembly 10 range from filtration medias to selective ion resins to spiral wound membranes. Each filtration media, resin or membrane have specific performance properties and when combined can act as an integrated water treatment solution. In particular, a low operating pressure membrane, such as those manufactured by AXEON Water Technologies of Temecula, Calif., that operates at only 80 psi operating pressure may be utilized. The use of this membrane allows functionality within the encapsulated configuration described herein. In addition, due to the unique design of the assembly 10, the RO membrane does not require a brine seal, anti-telescoping device, or a carrier and due to this will not house stale water that normally develops behind the brine seal like many of the membranes do today in standard membrane housing assemblies. This provides for an almost “sanitary like design.”

In addition to the above features and benefits, these encapsulations would allow for system builders to eliminate the need for standard membrane housings, thus offering a substantial reduction in costs. By utilizing various media within the encapsulated assemblies, a single assembly may be used by itself to treat a particular application or multiple assemblies may be plumbed together to create a complete, custom solution for a particular application. Applications include almost any residential, light commercial, commercial, industrial applications which can include residential, foodservice, small business, vending, coffee, marine to name a few.

While other water purification manufacturers have attempted to market housingless media, they utilize a cartridge design that plugs into a manifold, in contrast to those envisioned by the present application which do not require a manifold, as the assemblies may be plumbed directly together without the use of a manifold and feature a much higher flow rate.

The above description is given by way of example, and not limitation. Given the above disclosure, one skilled in the art could devise variations that are within the scope and spirit of the invention disclosed herein, including various ways of securing the end caps to the core member, connecting the assembly to a water supply, and various sizes and configurations of assemblies. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A disposable encapsulated water purification media assembly comprising:
a hollow cylindrical core member;
a top end cap permanently attached to a top portion of the cylindrical core member, wherein the top end cap includes a side port;
a bottom end cap permanently attached to a bottom portion of the cylindrical core member, wherein the bottom end cap includes a side port disposed on the opposite side in relation to the top end cap side port;
wherein the cylindrical core member, top end cap, and bottom end cap form a void; and
a water purification media contained directly within the void.

2. The disposable encapsulated water purification media assembly of claim 1 wherein the assembly is capable of being attached to a water supply without the use of a separate housing.

3. The disposable encapsulated water purification media assembly of claim 1 wherein the assembly is capable of being directly attached to a water supply without the use of a manifold.

4. The disposable encapsulated water purification media assembly of claim 1 wherein the hollow cylindrical core member, top end cap, and bottom end cap are formed from acrylonitrile butadiene styrene (ABS).

5. The disposable encapsulated water purification media assembly of claim 1 wherein both side ports are 1/2 inch.

6. The disposable encapsulated water purification media assembly of claim 1 wherein both side ports are 3/4 inch.

7. The disposable encapsulated water purification media assembly of claim 1 wherein the bottom side port is 3/4 inch and the top side port is 1/2 inch.

8. The disposable encapsulated water purification media assembly of claim 1 wherein the side ports are female national pipe thread (FNPT).

9. The disposable encapsulated water purification media assembly of claim 1 wherein the side ports are push-to-connect.

10. The disposable encapsulated water purification media assembly of claim 1 wherein the water purification media is a filtration media.

11. The disposable encapsulated water purification media assembly of claim 10 wherein the filtration media is carbon.

12. The disposable encapsulated water purification media assembly of claim 11 wherein the bottom side port is a water entry port and the top side port is a water exit port.

13. The disposable encapsulated water purification media assembly of claim 1 wherein the water purification media is a reverse osmosis membrane.

14. The disposable encapsulated water purification media assembly of claim 13 wherein the bottom side port is a water entry port, the top side port is a waste exit port, and the top end cap further includes a centrally located purified water exit port.

15. The disposable encapsulated water purification media assembly of claim 13 wherein the reverse osmosis membrane operates at a pressure of approximately 80 psi.

16. The disposable encapsulated water purification media assembly of claim 1 wherein the water purification media is a selective ion resin.

17. A water purification system comprising at least one encapsulated water purification media assembly connectable to an incoming water supply, wherein the encapsulated water purification media assembly comprises:
a hollow cylindrical core member;
a top end cap permanently attached to a top portion of the cylindrical core member, wherein the top end cap includes a side port;
a bottom end cap permanently attached to a bottom portion of the cylindrical core member, wherein the bottom end cap includes a side port disposed on the opposite side in relation to the top end cap side port;
wherein the cylindrical core member, top end cap, and bottom end cap form a void; and
a water purification media contained directly within the void.

18. The water purification system of claim 17 comprising at least two encapsulated water purification media assemblies, wherein said encapsulated water purification media assemblies are attached in a serial fashion.

19. The water purification system of claim 18, wherein the at least two encapsulated water purification media assemblies are plumbed directly together without the use of a manifold.
